(19) United States
(12) Patent Application Publication
(10) Pub. No.: US 2020/0089206 A1
(43) Pub. Date: Mar. 19, 2020

(54) UNMANNED AERIAL VEHICLE (UAV) AND A SYSTEM FOR MONITORING AND MAINTAINING LUMINAIRES USING THE UAV

(71) Applicant: Greenstar Research and Development India Pvt Ltd, Gurgaon (IN)

(72) Inventors: Sumant MUKHERJEE, Gurgaon (IN); Tom WRIGHT, Gurgaon (IN)

(21) Appl. No.: 16/597,316

(22) Filed: Oct. 9, 2019

(30) Foreign Application Priority Data
Oct. 10, 2018 (IN) 201811038510

(51) Int. Cl. G05B 23/02; B64C 39/02; G06F 1/3206; G05D 1/10; G05D 1/00; H04W 4/029

(52) U.S. Cl. CPC G05B 23/0283; B64C 39/024; G06F 1/3206; B64C 2201/12; G05D 1/0088; H04W 4/029; G05D 1/101

(57) ABSTRACT

A system for monitoring and maintaining luminaires using an unmanned aerial vehicle. The system comprises one or more luminaires, a computing device and one or more Unmanned Aerial Vehicle. The computing device receives the information about the working condition of the one or more luminaires accordingly generate a command for a UAV of the one or more UAVs to diagnose and identify one or more issues with the one or more luminaires causing the faulty condition.

### FIELD OF THE INVENTION

Embodiments of the present invention generally relates to technologies involving maintenance of lighting systems and more particularly to an unmanned aerial vehicle (UAV) and a system for monitoring and maintaining luminaires using the UAV.

### BACKGROUND OF THE INVENTION

Electronic devices such as luminaires etc. often need to be assessed for performance, serviced for effective working, repaired or replaced. This becomes a bit problematic and time taking when it comes to luminaires mounted on long/high poles. The presently available solution is totally man operated and is very risky for the service personnel to work at such a unsafe height. When it comes to replacement of the complete luminaire the currently adopted procedure of lifting the personnel up to the height of the faulty luminaire seems to be effective but in case of assessing and finding the problematic area or parts, one needs to spend time up there and that is really dangerous. Unmanned Aerial Vehicles (UAV) have emerged as one of the most exciting prospects for futuristic innovations. New applications using the UAVs are gaining popularity rapidly. Some of the applications utilize hovering capabilities of UAVs to reach places where it is difficult for a human to be present, be it for monitoring or service and maintenance work.

Recently, the UAVs have been utilized for servicing work of electronic devices such as luminaires. This has proved beneficial for humans who do not have to risk their life for replacing luminaires. Though the existing methods/systems strive to provide solutions to the problem discussed above, however, most or all of them come with a number of limitations or shortcomings. The replacement work only requires removal of the faulty luminaire and placement of the new one. But presently none of the available solutions accomplish the performance test as well as repair work. In case the failure isn't related to the installed luminaire, the UAVs replacing the luminaire won't solve the problem. Problem may be in the electronic setup around the luminaire and problems such as over voltage, under voltage, burn-out of feeder supply wires etc. require testing first. But existing systems and UAVs are not able to solve the problem and for such problems, human worker is required to risk his life.

Therefore, there remains a need in the art for an unmanned aerial vehicle (UAV) and a system for monitoring and maintaining luminaires using the UAV, that does not suffer from above mentioned deficiencies or at least provides a viable and effective solution.

### SUMMARY OF THE INVENTION

The present invention is described hereinafter by various embodiments. This invention may, however, be embodied in many different forms and should not be construed as limited to the embodiment set forth herein.

According a first aspect of the invention, a system for monitoring and maintaining luminaires using an unmanned aerial vehicle is provided. The system comprises a first plurality of sensors configured to generate a plurality of first values indicative of a first one or more parameters of the one or more luminaires, a light module configured to receive the plurality of first values and determine the first one or more parameters of the one or more luminaires based on the respective plurality of first values received, thereby providing an information about the working condition of the one or more luminaire, a computing device in communication with the respective light module of each of the one or more luminaires and one or more Unmanned Aerial Vehicles (UAVs). The computing device comprises a memory unit configured to store machine-readable instructions and a processor operably connected with the memory unit, the processor obtaining the machine-readable instructions from the memory unit, and being configured by the machine-readable instructions to receive the information about the working condition of the one or more luminaires, the working condition being normal or faulty and generate a command for a UAV of the one or more UAVs to diagnose and identify one or more issues with the one or more luminaires causing the faulty condition, rectify the identified one or more issues with the one or more luminaires.

In accordance with an embodiment of the present invention, the system further comprises the processor is configured to send a location of the faulty luminaire of the one or more luminaires and the UAV is configured to reach the location of the faulty luminaire for diagnosis.

In accordance with an embodiment of the present invention, the one or more issues of the one or more luminaires are selected from a group comprising, but not limited to, luminaire malfunction/replacement, undervoltage condition, overvoltage condition, leakage of current, high/low energy consumption, scheduled maintenance and circuit or part malfunction.

In accordance with an embodiment of the present invention, the one or more luminaires are selected from a group comprising, but not limited to, streetlights, High bay lights, stadium lights and rail track lights.

In accordance with an embodiment of the present invention, the one or more luminaires is selected from a group comprising, but not limited to, an arc lamp, an incandescent light, a fluorescent lamp, a mercury vapor, high pressure sodium, metal halide, induction lamps and Light Emitting Diodes (LEDs), flood lights or combination thereof.

In accordance with an embodiment of the present invention, the first plurality of sensors is selected from a group comprising, but not limited to, a temperature sensor, a proximity sensor, a dust sensor, an ambient light sensor, a photodiode sensor, an air sensor, a voltage sensor, a current sensor or combination thereof.

In accordance with an embodiment of the present invention, the computing device is selected from a group comprising, but not limited to, a portable computing device, a desktop computer and a server stack.

In accordance with an embodiment of the present invention, the system further comprises a respective remote controller for each of one or more UAVs, the remote controller being configured to control an operation of the respective UAV using wireless communication network.

In accordance with an embodiment of the present invention, the light module is configured to turn ON the power and turn OFF the power, for a predetermined time upon receiving commands from the UAV.

In accordance with an embodiment of the present invention, the one or more luminaires are connected with a respective solar panel. Further, the one or more UAVs are further configured to clean the respective solar panel, diagnose the solar panel and also luminaire as per the requirement or a predetermined schedule.

According to a second aspect of the present invention, an Unmanned Aerial Vehicle (UAV) for servicing one or more luminaires mounted on respective one or more Poles is provided. The one or more UAV have a chassis, one or more motors, propellers attached to the chassis, an electronic speed controller, a flight controller, a communication module, a battery and a battery charger, the UAV comprises a second plurality of sensors, configured to sense a second plurality of values indicative of a second one or more parameters of a luminaire of the one or more luminaires, one or more robotic arms having respective claws, a processing module configured to receive the second plurality of values from the one or more sensors and process the second plurality of values to determine the one or more parameters, determine a working condition of the luminaire based on the one or more parameters, the working condition being a normal condition or a faulty condition, identifying one or more issues in a faulty luminaire, rectify the identified one or more issues in the faulty luminaires using the one or more robotic arms to perform a required function.

In accordance with an embodiment of the present invention, the second plurality of sensors, one or more robotic arms and image capturing device are configured to repair and/or replace the one or more luminaires, light module, electronic circuits/parts and clean the one or more luminaires and solar panel.

In accordance with an embodiment of the present invention, the second plurality of one or more sensors are selected from a group comprising, but not limited to, 3 axis accelerometer, 3-axis gyroscope, Magnetometer, Barometer, GPS Sensor, Distance Sensor, Infrared sensor, permanent magnets, magnetic field sensor, thermal imaging camera or a combination thereof.

In accordance with an embodiment of the present invention, the UAV further comprises an image capturing device configured to capture visuals around the one or more luminaires, a thermal image capturing device configured to capture thermal images around the one or more luminaires or solar panels, a testing module configured to test electrical connections/parameters of the one or more luminaires, a communication module configured to act as a honey pot, comprising one or more transmitter to provide open Wi-Fi network for user, a content display module configured to display the feature parameter includes the weight, discharge rate, voltage of the UAV, a tracking module configured to track the particular position of the one or more luminaires to identify and rectify the problem, one or more attachment pads configured to provide easy attachment and detachment of the one or more luminaires.

In accordance with an embodiment of the present invention, the testing module are selected from a group comprising, but not limited to, include one or more of ammeter, voltmeter, multi-meter, clamp-meter, power meter, oscilloscope, function generator or other instrument capable of testing an electronic circuit or a combination thereof.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein

FIG. 1 illustrates a system for monitoring and maintaining luminaires using Unmanned Aerial Vehicles (UAVs), in accordance with an embodiment of the present invention;

FIG. 2 illustrates a block diagram of an UAV, in accordance with an embodiment of the present invention;

FIG. 3A illustrates information diagram flow of the system for monitoring luminaires, using UAV, in accordance with an embodiment of the present invention;

FIG. 3B illustrates information flow diagram of the system for identification and rectification of issues with faulty luminaire using the UAV, in accordance with an embodiment of the present invention; and

FIG. 4 illustrates a pictorial representation of the implementation of the being used for monitoring and testing a luminaire, in accordance with an embodiment of the present invention.

### DETAILED DESCRIPTION OF THE DRAWINGS

The present invention is described hereinafter by various embodiments with reference to the accompanying drawing, wherein reference numerals used in the accompanying drawing correspond to the like elements throughout the description.

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

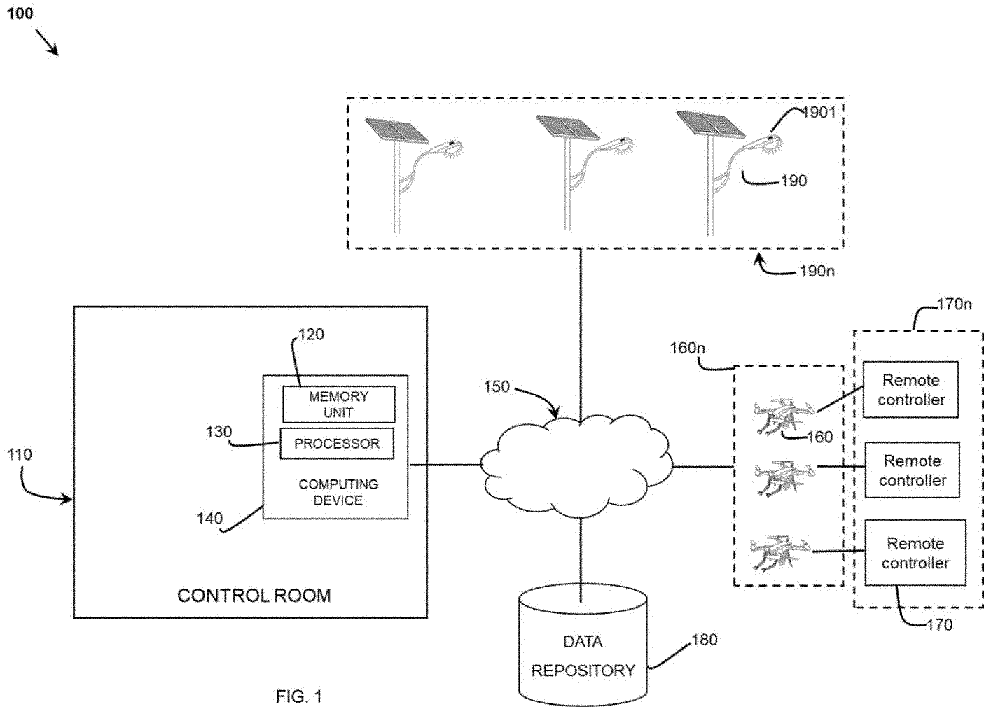

FIG. 1 illustrates a system (100) for monitoring and maintaining luminaires using Unmanned Aerial Vehicles (UAVs) (160n), in accordance with an embodiment of the present invention. As shown in FIG. 1, the system (100) comprises a one or more luminaires (190n). The one or more luminaires (190n) may be, but not limited to, an arc lamp, an incandescent light, a fluorescent lamp, a mercury vapor, high pressure sodium, metal halide, induction lamps and Light Emitting Diodes (LEDs), flood lights etc. The one or more luminaire (190n) is mounted on a pole used in stadium lights, streetlights, high bay lighting, rail track lighting etc. Each of the one or more luminaires (190n) comprises a first plurality of sensors (not shown in FIG. 1) and a light module (1901).

The first plurality of sensors are configured to generate a plurality of first values indicative of a first one or more parameters of the one or more luminaires (190n). The first plurality of sensors (1902) is selected from a group comprising, but not limited to, a temperature sensor, a proximity sensor, a dust sensor, an ambient light sensor, a photodiode sensor, a voltage sensor, a current sensor or combination thereof. The one or more parameters may be, but not limited to, voltage, current, energy consumption and circuit condition. Additionally, the light module is configured to receive the plurality of first values and determine the first one or more parameters of the one or more luminaires (190n) based on the respective plurality of first values received, thereby providing an information about the working condition of the one or more luminaire (190n).

In this regard, the light module (1901) is envisaged to include processing capabilities. The light module (1901) is envisaged to include pre-stored ideal values of the one or more parameters. The pre-stored values may be compared with the measured values of the one or more parameters to determine the working condition of the one or more luminaires (190n). For example: if pre-stored ideal value of the voltage is 220V and the measured value is 250V, then the light module (1901) would determine the luminaire to be in the faulty condition (overvoltage).

The system (100) further comprises a computing device (140). The computing device (140) is placed in a control room (110) (at a central location) and is connected with the one or more luminaires (190n) using a communication network (150). The communication network (150) may be implemented using a number of protocols, such as but not limited to, TCP/IP, 3GPP, 3GPP2, LTE, IEEE 802.x etc. The communication network (150) may be wireless communication network selected from one of, but not limited to, radio frequency, WIFI network or satellite communication network providing maximum coverage. The computing device (140) may be, but not limited to, a portable computing device, a desktop computer or a server stack.

The computing device (140) is envisaged to include computing capabilities such as a memory unit (120) configured to store machine readable instructions. The machine-readable instructions may be loaded into the memory unit (120) from a non-transitory machine-readable medium such as, but not limited to, CD-ROMs, DVD-ROMs and Flash Drives. Alternately, the machine-readable instructions may be loaded in a form of a computer software program into the memory unit (120). The memory unit (120) in that manner may be selected from a group comprising EPROM, EEPROM and Flash memory. Further, the computing device (140) includes a processor (130) operably connected with the memory unit (120). In various embodiments, the processor (130) is one of, but not limited to, a general-purpose processor, an application specific integrated circuit (ASIC) and a field-programmable gate array (FPGA). Further the computing device (140) is connected with a data repository (180). The data repository (180) may be a cloud-based storage or a local storage. In any manner, the data repository (180) is envisaged to be capable of providing the data to any of the computing devices (140) connected with the communication network (180), when the data is queried appropriately using applicable security and other data transfer protocols.

The system (100) further comprises one or more Unmanned Aerial Vehicles (160n). The one or more UAVs (160n) are in communication with the computing device (140). For example: if an area includes 100 luminaires, then there may be 10 UAVs in the system, each UAV being configured to manage the luminaires in a particular zone of the area. Further the one or more UAVs (160n) may be connected with a respective remote controller using the wireless network. Herein, it is envisaged that the computing device (140) is connected with one or more UAVs (160n) within a predetermined area whereas a remote controller (170) is connected with only one of the one or more UAVs (160n).

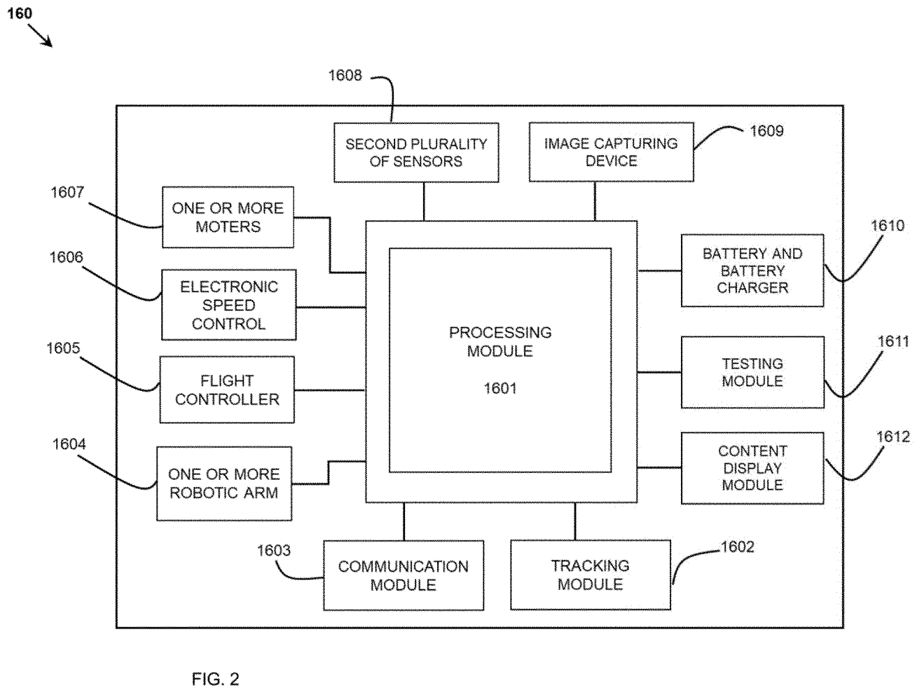

FIG. 2 illustrates a block diagram of a UAV (160) of the one or more UAVs (160n), in accordance with an embodiment of the present invention. The UAV (160) is envisaged to comprise a chassis (frame of the UAV (160)) (not shown in this fig), one or more motors (1607) and propellers (not shown in this fig) attached to the chassis, one or more legs (not shown in this fig), an Electronic Speed Controller (ESC) for each motor that supplies the proper modulated current to the motors, which in turn produce correct rates of spin for both lift and maneuvering, a flight controller (1605) for controlling the UAV (160), a communication module (1603) for communicating with the flight controller (1605) and the remote controller (170) by receiving network signals from the remote controller (170) and transmitting them to the flight controller (1605), a battery and battery charger (1610) to power the UAV (160).

The UAV (160) shown in FIG. 2, further comprises a second plurality of sensors (1608), one or more robotic arms (1604), an image capturing device (1609) and testing module (1611). These are used to detect and identify one or more issues with the one or more luminaires (190n) indicative of a working condition of the one or more luminaires (190n). The working condition may be a normal working condition or a faulty condition caused by the one or more issues. The one or more issues may be, but not limited to, luminaire malfunction/replacement, undervoltage condition, overvoltage condition, leakage of current, high/low energy consumption, scheduled maintenance and circuit malfunction etc. The second plurality of sensors (1608) may include, but not limited to, 3 axis accelerometer, 3-axis gyroscope, Magnetometer, Barometer, GPS Sensor, Distance Sensor, Infrared sensor, permanent magnets and magnetic field sensor. The one or more robotic arms (1604) are capable of the carrying weight and offer a variety of motions. The arms are also envisaged to have holding means such as a claw (not shown in FIG. 2) at a free end of the one or more arms. The testing module (1611) may include one or more of, but not limited to, ammeter, voltmeter, multi-meter, clamp-meter, power meter, oscilloscope, function generator or other instrument capable of testing an electronic circuit. Further, the UAV (160) may comprise a communication module (1603), a content display module (1612) to display the parameters (such as a weight, a discharge rate, a voltage of the UAV (160)), a tracking module (1602), a storage module and an information module. The communication module (1603) is configured to act as a honey pot, comprising one or more transmitters to provide open Wi-Fi network for a user. The tracking module (1602) may include, but not limited to, wireless trackers like GPS, optical tracking, magnetic tracking, sensor fusion etc.

Additionally, the UAV (160) comprises a processing module (1601). The processing module (1601) is connected with all above mentioned components of the UAV (160) as shown in FIG. 2. The system (100) may further comprise artificial intelligence and machine learning based technologies, but not limited to, for data analysis, collating data, presentation of data in real-time.

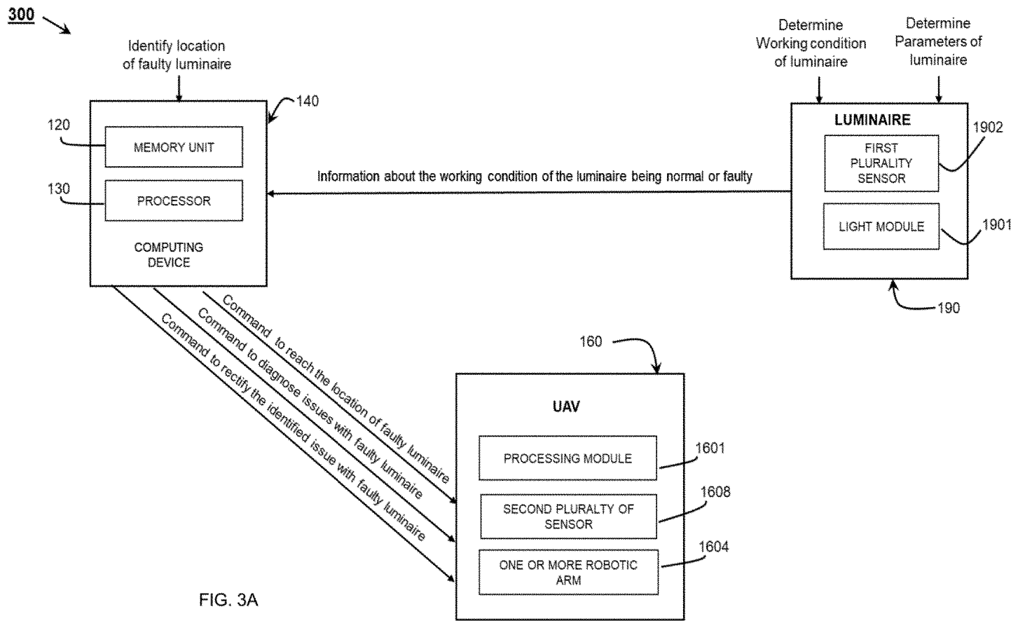

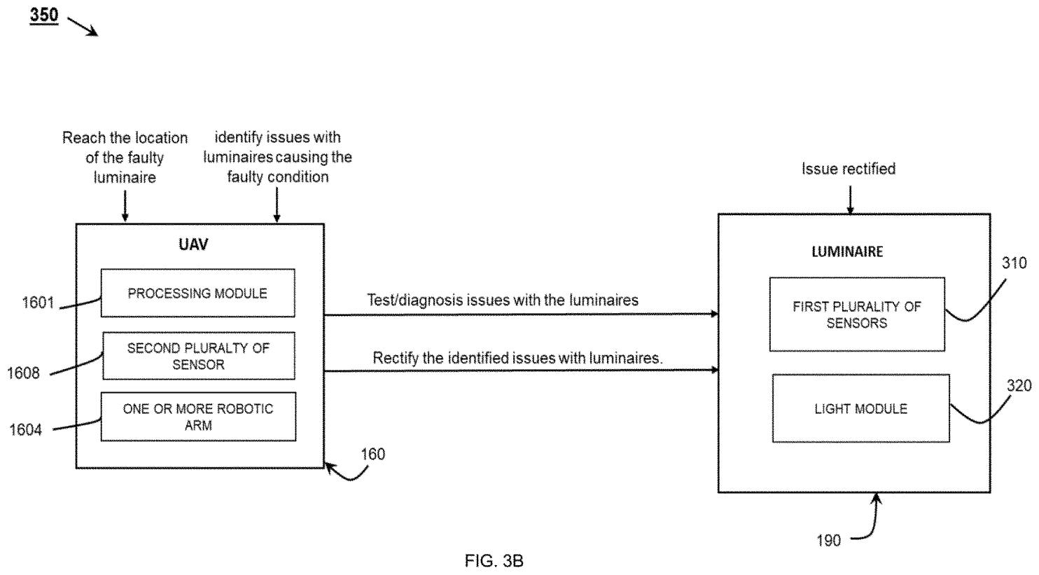

FIG. 3A illustrates an information flow diagram of the system (100) for monitoring luminaires (190), using UAV (160), in accordance with an embodiment of the present invention. As shown in FIG. 3, the first plurality sensors (1902) of a luminaire (190) of the one or more luminaires (190n), generate a respective plurality of first values, indicative of a first one or more parameters of the luminaire (190). The light module (1901) is configured to receive the plurality of first values and determine the first one or more parameters of the luminaire (190n). After comparison with pre-stored ideal parameters, the light module (1901) generates an information about the working condition of the one or more luminaires. For example, the light module (1901) may determine the luminaire (190) to be in faulty condition (over voltage, under voltage, overheat etc.) or normal condition (working fine).

In system (100), the one or more luminaires (190n) are in communication with the computing device (140). So, the respective light modules of each of the one or more luminaires (190n) communicate the working condition of each of the one or more luminaires (190n) to the computing device (140). The processor (130) receives the information about the working condition of the one or more luminaires (190n) being normal or faulty. According to the information received, the processor (130) identifies the location/locations of one or more faulty luminaires. For the sake of explanation, it is envisaged that only one luminaire (190) is determined to be faulty.

Accordingly, the processor (130) is configured to generate a command or direct a UAV (160) of one or more UAVs (160n) to reach a location of the faulty luminaire (190) by using tracking module (1602). The UAV (160) is then instructed to diagnose and identify the issue with faulty luminaire (190). In one embodiment, the UAV may directly connect with the light module upon reaching the location of the faulty UAV (190) to know the determined one or more issues. In another embodiment, the UAV (160) may itself diagnose and identify the one or more issues by accessing the electronic circuit and components of the faulty luminaire (190) using the second plurality of sensors and the robotic arms and claws.

For example: the testing module (1611) is used to test electrical connection/parameters of the luminaire (190), the image capturing device (1609) (such as a camera) may capture the visual environmental condition around the luminaire (190), the second plurality of sensors (1608) may be used to determined the second one or more parameters of faulty luminaire (190) and transmit details of a sensed and tested parameters to processing module (1601) of the UAV (160). The second one or more parameters may include, but not limited, temperature, voltage, current, moisture, luminaire malfunction. According to the sensed and tested parameters, the processing module (1601) used to identify the one or more issues of the faulty luminaire (190).

After identifying one or more issue in the faulty luminaire (190). The processing unit (1601) provides the command to rectify the identified the one or more issues in the faulty luminaire (190) using the one or more robotic arms. For example: In case there is a circuit malfunction, then the UAV (160) may be directed to test and repair the electronic circuit. In case, there is a damage caused to the luminaire due to over-voltage, over-heating etc., then the UAV (160) may be directed to find the problematic components causing the fault, rectify the problem and replace the luminaire/problematic components (if required). In case, if the issues are caused by the accumulation of dust, then the UAV (160) is envisaged to clean the circuitry and surroundings of the faulty luminaire (190).

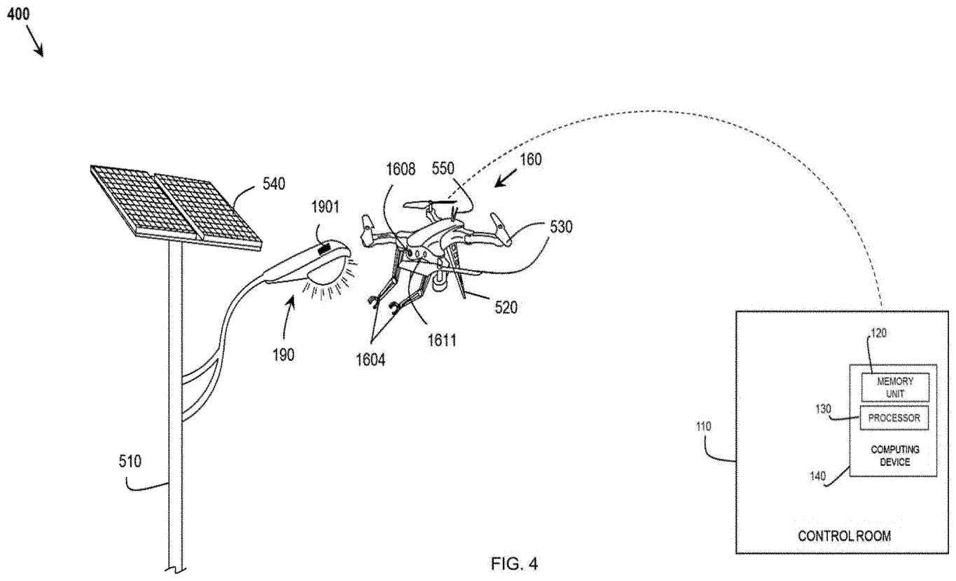

FIG. 4 illustrates a pictorial representation of the implementation Unmanned Aerial Vehicle (UAV) (160) being used for monitoring and testing a luminaire, in accordance with an embodiment of the present invention. As shown in FIG. 4, the luminaire (190) is mounted on a Pole (510). The luminaire (190) may be solar powered and one or more solar panels (540) may be connected with the luminaire (190) and mounted on the Pole (510).

In one embodiment, the UAV (160) may also assist in cleaning and/or replacing the solar panels from time to time or when required. Additionally, the artificial intelligence and the machine learning technologies enable the UAV (160) to learn several new electronic lighting systems/circuits, the assemblies and the overhauling methods.

In another embodiment, the UAV (160) further comprises one or more attachment pads for easy attachment and detachment of the luminaire sensors (1902). Using a small control board with blue tooth radio to power attachment pads on the UAV(190) and operate in conjunction with the UAV (160) that is delivering or retrieving the sensor from the luminaire (190). The attachment pad would be an electro-magnetic surface that is always powered. When a drone delivers a sensor for the first time it would automatically attach without communication between the UAV (160) and the luminaire 190's light module (1901). If the sensor needs to be retrieved, the UAV 160 would issue a blue tooth command to the light module (1901) to turn off the power for a predetermined time, say 3 mins, long enough for the UAV 160 to grab the sensor and fly away.

In another embodiment, the communication module of the UAV (160) also comprises one or more transmitters (550) creating an open Wi-Fi network for users to connect and act as a honey pot. In general, a honey pot is set up to act as a decoy to lure cyber attackers, and to detect, deflect or study attempts to gain unauthorized access to information systems. It is well known that open access networks are preferred for cyber-attacks. This will provide an advantage of monitoring cyber activity of potential hackers and prevent cyber crimes as the network coverage of drone will be much more than the conventional honey pots. In case of detection of any illegal activity over the Wi-Fi network, the computer system may easily trap the cyber attacker and also inform the law enforcement authorities.

In yet another embodiment, the computer device (140) may be configured to receive the notification as soon as a luminaire (190) and the automatically the coordinates of the location of the luminaire (190) are sent to the UAV (160) nearest to the location, thereby automating the whole process.

The present invention offers a number of advantages. Firstly, the present invention widens the scope of the UAVs to the luminaire testing and servicing. Unlike presently available systems and devices the present invention can be used to find/identify the problem in a luminaire set up or perform a simple testing check to ensure all the components of the electronic set up around the luminaire are working fine. It is advantageous as testing and servicing is time consuming and requires human workers to reach the luminaire and stay high up there risking their life, to test and repair the circuitry around the luminaire.

In general, the word “module,” as used herein, refers to logic embodied in hardware or firmware, or to a collection of software instructions, written in a programming language, such as, for example, Java, C, Python or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, one would appreciate that a communication network may also be used in the system. The communication network can be a short-range communication network and/or a long-range communication network, wire or wireless communication network. The communication interface includes, but not limited to, a serial communication interface, a parallel communication interface or a combination thereof. The communication is established over may be, but not limited to, wired network or wireless network such as GSM, GPRS, CDMA, Bluetooth, Wi-fi, Zigbee, Internet, intranet.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publicly accessible network such as the Internet.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer device, or similar electronic computing device, that processes and transforms data represented as physical (electronic) quantities within the computing device registers and memories into other data similarly represented as physical quantities within the computing device memories or registers or other such information storage, transmission or display devices.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention.

We claim:

1. A system for monitoring and maintaining luminaires using an unmanned aerial vehicle, the system comprising:
one or more luminaires, each comprising:
a first plurality of sensors, configured to generate a plurality of first values indicative of a first one or more parameters of the one or more luminaires; and
a light module, configured to receive the plurality of first values and determine the first one or more parameters of the one or more luminaires based on the respective plurality of first values received, thereby providing an information about the working condition of the one or more luminaire;
a computing device in communication with the respective light module of each of the one or more luminaires and one or more Unmanned Aerial Vehicles (UAVs), the computing device comprising:
a memory unit configured to store machine-readable instructions; and
a processor operably connected with the memory unit, the processor obtaining the machine-readable instructions from the memory unit, and being configured by the machine- readable instructions to:
receive the information about the working condition of the one or more luminaires, the working condition being normal or faulty; and
generate a command for a UAV of the one or more UAVs to:
diagnose and identify one or more issues with the one or more luminaires causing the faulty condition;
rectify the identified one or more issues with the one or more luminaires.

2. The system as claimed in claim 1, wherein the processor is configured to send a location of the faulty luminaire of the one or more luminaires and the UAV is configured to reach the location of the faulty luminaire for diagnosis.

3. The system as claimed in claim 1, wherein the one or more issues of the one or more luminaires are selected from a group comprising luminaire malfunction/replacement, undervoltage condition, overvoltage condition, leakage of current, high/low energy consumption, scheduled maintenance and circuit malfunction.

4. The system as claimed in claim 1, wherein the one or more luminaires are lights, selected from a group comprising streetlights, highway lights, stadium lights and rail track lights.

5. The system as claimed in claim 1, wherein the one or more luminaires is selected from a group comprising an arc lamp, an incandescent light, a fluorescent lamp, a mercury vapor, high pressure sodium, metal halide, induction lamps and Light Emitting Diodes (LEDs), flood lights or combination thereof.

6. The system as claimed in claim 1, wherein the first plurality of sensors is selected from a group comprising a temperature sensor, a proximity sensor, a dust sensor, an ambient light sensor, a photodiode sensor, a voltage sensor, a current sensor or combination thereof.

7. The system as claimed in claim 1, wherein the computing device is selected from a group comprising a portable computing device, a desktop computer and a server stack.

8. The system as claimed in claim 1, further comprising a respective remote controller for each of one or more UAVs, the remote controller being configured to control an operation of the respective UAV using wireless communication network.

9. The system as claimed in claim 1, further the light module is configured to turn OFF the power, for a predetermined time upon receiving commands from the UAV.

10. The system as claimed in claim 1, wherein the one or more luminaires are connected with a respective solar panel, wherein the one or more UAVs are further configured to clean the respective solar panel as per the requirement or a predetermined schedule.

11. An Unmanned Aerial Vehicle (UAV) for servicing one or more luminaires mounted on respective one or more Poles having a chassis, one or more motors, propellers attached to the chassis, an electronic speed controller, a flight controller, a communication module, a battery and a battery charger, the UAV comprising:
a second plurality of sensors, configured to sense a second plurality of values indicative of a second one or more parameters of a luminaire of the one or more luminaires;
one or more robotic arms having respective claws;
a processing module configured to:
receive the second plurality of values from the second plurality of sensors and process the second plurality of values to determine the one or more parameters;
determine a working condition of the luminaire based on the one or more parameters, the working condition being a normal condition or a faulty condition;
identifying one or more issues in a faulty luminaire; and
rectify the identified one or more issues in the faulty luminaires using the one or more robotic arms to perform a required function.

12. The UAV as claimed in claim 11, wherein the second plurality of sensors and one or more robotic arms configured to repair and/or replace the one or more luminaires, light module, electronic circuits/parts and clean the one or more luminaires and solar panel.

13. The UAV as claimed in claim 11, wherein the second plurality of sensors are selected from a group comprising 3 axis accelerometer 3 axis accelerometer, 3-axis gyroscope, magnetometer, barometer, GPS sensor, distance sensor, infrared sensor, permanent magnets, magnetic field sensor, thermal imaging camera or a combination thereof.

14. The UAV as claimed in claim 11, further comprising:
an image capturing device configured to capture visuals around the one or more luminaires;
a testing module configured to test electrical connections of the one or more luminaires
a communication module configured to act as a honey pot, comprising one or more transmitter to provide open Wi-Fi network for user;
a content display module configured to display the feature parameter includes the weight, discharge rate, voltage of the UAV;
a tracking module configured to track the particular position of the one or more luminaires to identify and rectify the problem;
one or more attachment pads configured to provide easy attachment and detachment of the one or more luminaires.

15. The UAV as claimed in claim 11, wherein the testing module includes one or more of ammeter, voltmeter, multi-meter, clamp-meter, power meter, oscilloscope, function generator or other instrument capable of testing an electronic circuit or a combination thereof.
